(19) United States
(12) Patent Application Publication
(10) Pub. No.: US 2005/0205596 A1
(43) Pub. Date: Sep. 22, 2005

(54) Self-locking anti-pilfer gate for a vending machine

(75) Inventor: Paul Hayward Kelly, Aiken, SC (US)

Correspondence Address: DIEDERIKS & WHITELAW, PLC, 12471 Dillingham Square, #301, Woodbridge, VA, 22192, US

(73) Assignee: Maytag Corporation

(21) Appl. No.: 10/787,936

(22) Filed: Feb. 27, 2004

(51) Int. Cl. G07F 11/00; B65H 3/60; B65G 59/00; G07F 11/12; B65H 3/00

(52) U.S. Cl. 221/109

(57) ABSTRACT

A vending machine includes a product storage area, a dispensing chamber, a chute zone that interconnects the product storage area with the dispensing chamber, and a self-locking gate assembly having a gate member. The gate assembly is pivotally mounted to a frame member that is positioned at the chute zone. A latch member selectively secures the gate member to the frame member. The latch member is operatively connected to a trigger plate that disengages the latch member when the trigger plate is abutted by a product container such that the gate member shifts from a closed position to an open position, allowing the product container to pass into the dispensing chamber. The gate member then automatically closes and the latch member re-engages so as to prevent unauthorized removal of products from the vending machine.

### BACKGROUND OF THE INVENTION

1. Field of the Invention

The present invention pertains to the art of vending machines and, more particularly, to a self-locking anti-pilfer gate for preventing unauthorized removal of products from a vending machine.

2. Discussion of the Prior Art

Certain types of vending machines include a glass front that covers a storage/display region. The glass front enables a consumer to view various choices available for selection. After currency is deposited into an appropriate receptacle and a selection is made, the selected product is moved from the storage/display region to a dispensing chamber of the vending machine. Typically, the dispensing chamber is accessed through a product delivery opening provided on a front face portion of the vending machine.

In order to retrieve the selected product, a consumer must access the dispensing chamber. However, in many cases, the dispensing chamber can also be used to gain unauthorized access to the product storage/display region. An individual that does not wish to pay for a product can insert a probe, generally in the form of a wire coat hanger, through the dispensing chamber up into the product storage/display region to withdraw a product without paying. This problem is particularly true in glass front vending machines, as the glass front enables a thief to view, and guide the tool toward a proposed target. Without a barrier to prevent unauthorized access to the product storage/display region, product losses will continue. While there exist several different methods of preventing access to the stored products, many still enable a crafty individual to withdraw products without paying.

Based on the above, there still exists a need in the art for an improved anti-pilfering device for a vending machine. More specifically, there exists a need for an anti-pilfering device for a vending machine that includes a positive latching mechanism that prevents unauthorized access to stored products while, at the same time, enables selected products to efficiently pass from a product storage/display region into a dispensing chamber.

### SUMMARY OF THE INVENTION

The present invention is directed to a vending machine including a product storage area, a dispensing chamber, a chute zone that interconnects the product storage and dispensing chamber, and an access opening for removing products transferred from the product storage area to the dispensing chamber through the chute zone. In accordance with a preferred embodiment of the present invention, a gate assembly including a gate member is movably supported at the chute zone. More specifically, the gate member is movable between a closed position, wherein passage of products between the product storage area and the dispensing chamber and, correspondingly, access to the product storage area from the dispensing chamber, is prevented, and an open position, wherein passage of products between the product storage area and the dispensing chamber is permitted.

In further accordance with the present invention, the gate assembly preferably includes a frame member arranged at the chute zone and secured to a wall of the vending machine. The frame member includes a peripheral rim having a first edge portion, a second edge portion and a peripheral wall that defines a passage extending between the product storage area and the dispensing chamber. In accordance with one aspect of the invention, the frame member includes a plurality of tab members that snap-fittingly attached the frame member to a wall of the vending machine. The gate member is pivotally mounted to and, preferably, positioned entirely within the frame member when in the closed position.

In accordance with another aspect of the present invention, the gate assembly includes a latch element that engages with the peripheral wall of the frame member. The latch element locks the gate member in the closed position to prevent unauthorized access to the product storage area through the dispensing chamber. Preferably, the latch element is operatively connected to a trigger plate that is movably secured to the gate member. The trigger plate is biased away from the gate member through a spring element. With this construction, a product that is guided from the product storage area abuts the trigger plate, causing the latch element to disengage from the frame member. Once the latch element is disengaged, the gate member is free to shift from the closed position to the open position, allowing the product to transition into the dispensing chamber through the chute zone. Once the product passes into the dispensing chamber, a second spring element causes the gate member to return to the closed position, with the latch element re-engaging with the frame member.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is a perspective view of a vending machine incorporating a self-locking anti-pilfer gate constructed in accordance with the present invention;

FIG. 2 is an elevational side view of the self-locking anti-pilfer gate constructed in accordance with the present invention;

FIG. 3 is a perspective view of the self-locking anti-pilfer gate of FIG. 2;

FIG. 4 is an enlarged, partial cross-sectional view of a latch portion of the self-locking anti-pilfer gate constructed in accordance with the present invention shown in a closed position; and

FIG. 5 is an enlarged, partial cross-sectional view of the latch portion of the self-locking anti-pilfer gate constructed in accordance with the present invention shown moving toward an open position.

### DETAILED DESCRIPTION OF THE PREFERRED EMBODIMENT

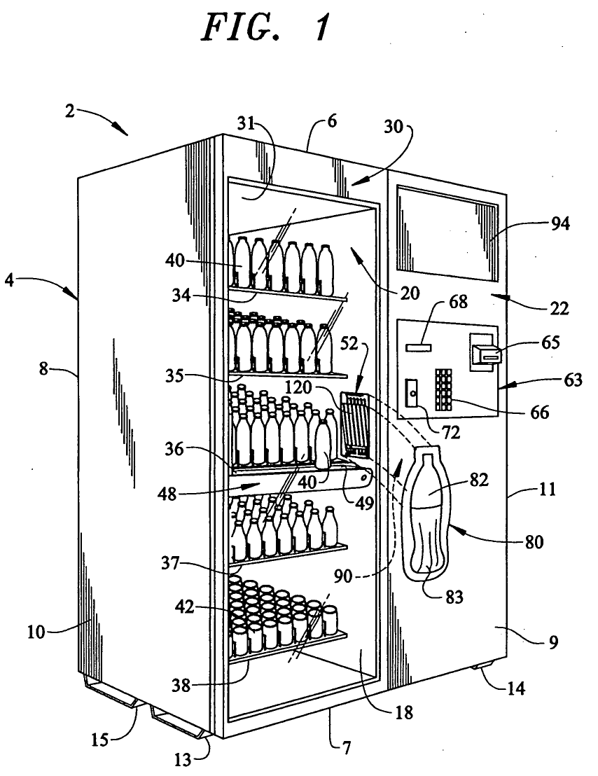

With initial reference to FIG. 1, a vending machine constructed in accordance with the present invention is generally indicated at 2. As shown, vending machine 2 includes a cabinet 4 having top, bottom, rear, front and opposing side walls 6-11. Arranged on bottom wall 7 are a plurality of support members, three of which are indicated at 13-15, that support vending machine 2 upon a supporting surface. In the embodiment shown, cabinet 4 includes a divider wall 18 that separates vending machine 2 into a product storage/display zone 20 and a control/product delivery zone 22. Product storage/display zone 20 is used to hold products in escrow until a vending operation is performed, while control/product delivery zone 22 receives currency, enables product selection and includes an opening for withdrawing selected products.

In a manner known in the art, vending machine 2 includes a door 30 that extends across and selectively closes product storage/display zone 20. Door 30 is provided with a transparent zone or window 31 that enables a consumer to view various products available for selection in vending machine 2. Toward that end, a plurality of shelves 34-38 are arranged within product storage/display zone 20 so as to hold products in escrow prior to being selected by a consumer. As shown, shelves 34-38 are filled with a plurality of product containers, such as bottles 40 and cans 42. Once selected by a consumer, a product container 40 or 42 is transported to control/product delivery zone 22 by a product delivery system 48. In accordance with the embodiment shown, product delivery system 48 is vertically movable between adjacent bottom wall 7 and top wall 6 of cabinet 4 in front of shelves 34-38. Thus, depending upon the particular shelf 34-38 upon which the selected product container 40, 42 resides, product delivery system 48 moves to a required vertical position so as to receive the selected product container 40, 42. Once product delivery system 48 is adjacent the requisite shelf 34-38, a dispensing system (not shown) moves the selected product container 40, 42 onto product delivery system 48. At this point, product delivery system 48 shifts to a delivery position whereupon a conveyor belt 49, provided as part of product delivery system 48, carries the selected product container 40, 42 to an opening 52 formed in divider wall 18.

As further shown by way of example in FIG. 1, control/product delivery zone 22 includes a currency input/product selection portion 63 having a bill receiver 65, a keypad 66 and a display 68. Also arranged on currency input/product selection portion 63 is a lock mechanism 72. Arranged below currency input/product selection portion 63 is a product dispensing chamber 80 having an upper access opening 82 and a lower, closed section 83. In the embodiment depicted, product dispensing chamber 80 is shown to take the form or shape of a typical beverage bottle. However, it should be understood that various other shapes and/or configurations could be used without departing from the scope of the present invention. In any event, extending between product dispensing chamber 80 and opening 52 in divider wall 18 is a chute zone 90 that interconnects product storage/display zone 20 with control/product delivery zone 22 and, more particularly, product dispensing chamber 80. Also shown in connection with the present embodiment is an illuminated panel 94 which can be used to present various advertising or other information to a consumer in a manner known in the art. In general, the structure described above has been provided for the sake of completeness and to enable a better understanding of the overall invention. The present invention is particularly directed to a gate assembly 120 provided within opening 52 that prevents unauthorized access to product storage/display zone 20 through product dispensing chamber 80.

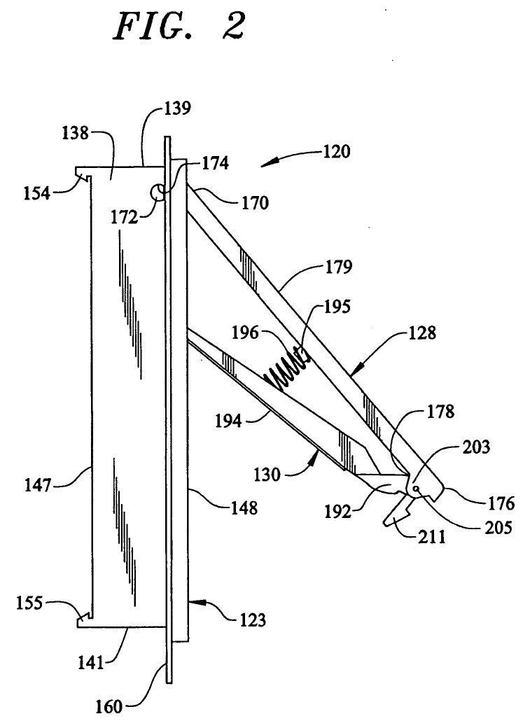

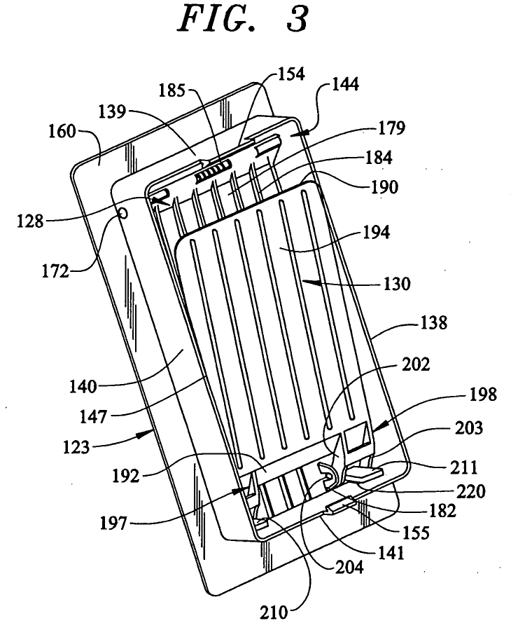

An embodiment of the present invention will now be described by way of example with reference to FIGS. 2-4. Initially, referring to FIGS. 2-3, gate assembly 120 includes a frame member 123, a gate member 128 and a trigger plate 130. As shown, frame member 123 includes a plurality of side walls 138-141 that collectively define a product opening 144. Side walls 138-141 include a first inner peripheral rim portion 147 that extends to a second peripheral rim portion 148. In the embodiment shown, arranged on first peripheral rim 147 are a plurality of tab members, two of which are indicated at 154 and 155, that snap-fittingly engage with corresponding structure (not shown) on divider wall 18 so as to fixedly mount frame member 123 within cabinet 4. Extending about and partially spaced from second peripheral rim 148 is a flange member 160 that sets an overall depth of frame member 123 within divider wall 18 so as to properly position gate member 128.

In further accordance with the embodiment shown, gate member 128 is shiftable between a closed position, as shown in FIG. 3, to an open position, as shown in FIG. 2. More specifically, gate member 128 includes a first end section 170 that is pivotally mounted to frame member 123 through a pivot or hinge pin 172. Actually, side walls 138 and 140 of frame member 123 are provided with a pair of openings, one of which is indicated at 174. Pivot pin 172 extends through gate member 128 and is positioned within openings 174 in frame 123 so as to enable gate member 128 to pivot about a substantially horizontal axis relative to frame member 123. In any event, first end 170 of gate member 128 extends to a second end 176 through a substantially planar portion 179. As shown, arranged at second end 176 of gate member 128 are a plurality of mounting ears, one of which is indicated at 182 in FIG. 3. As will be discussed more fully below, mounting ears 182 are adapted to cooperate with associated structure on trigger plate 130. In any event, extending across planar portion 179 of gate member 128 are a plurality of raised ribs 184 that act as stiffening elements for gate member 128. Finally, gate assembly 120 is provided with a spring, such as a torsion spring 185 arranged at first end 170 of gate member 128 which biases gate member 128 toward the closed position.

As further shown in FIGS. 2-3, trigger plate 130 includes a first end 190 that extends to a second end 192 through a paddle portion 194. Trigger plate 130 is actually pivotally attached to gate member 128. A first spring keeper 195 is provided on gate member 125 and a second spring keeper (not shown) is provided on trigger plate 130. A compression spring 196 extends between gate member 128 and trigger plate 130, with compression spring 196 being located by spring keeper 195 and functioning to bias trigger plate 130 away from gate member 128. In any event, second end 192 of trigger plate 130 is provided with first and second hinge knuckles 197 and 198 that pivotally connect trigger plate 130 to gate member 128. As each of hinge knuckles 197 and 198 is identical, a discussion will made with reference to hinge knuckle 198 with an understanding that hinge knuckle 197 has commensurate structure.

As best shown in FIG. 3, hinge knuckle 198 includes first and second side portions 202 and 203 provided with respective pivot pins 204 and 205 (FIG. 2). Pivot pins 204 and 205 are received in openings (not separately labeled) in mounting ears 182 which actually provide the overall pivot point for trigger plate 130. Provided between first and second side portions 202 and 203 of first and second hinge knuckles 197 and 198 are corresponding latch members 210 and 211 that retain gate member 128 in the closed position. As each latch member 210, 211 is similarly constructed, a detailed description of latch member 210 will be made with an understanding that latch member 211 has corresponding structure.

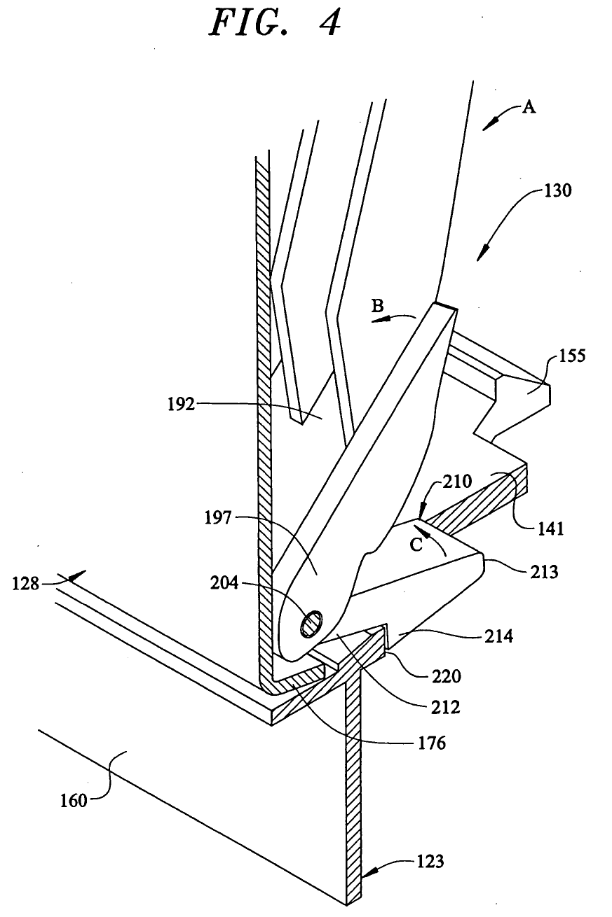

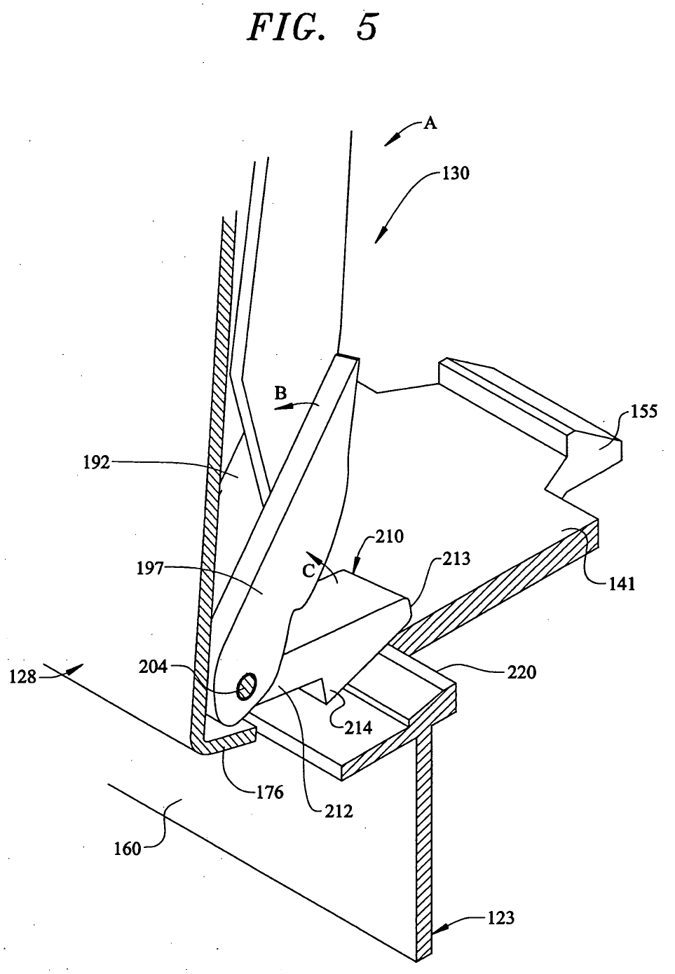

As best shown in FIG. 4, latch member 210 includes a first end 212 pivotally mounted relative to gate member 128 through respective pivot pins 204 and 205. First end 212 extends to a second end 213 through an intermediate hook portion 214. Hook portion 214 is, in accordance with the most preferred form of the invention, received in an opening or slot 220 formed in side wall 141 of frame member 123 when gate member 128 is in the closed position. In order to cause gate member 128 to shift from the closed or latched position as shown in FIGS. 3 and 4, to an open or release position as represented in FIG. 2, latch members 210 and 211 must be deflected so as to clear openings 220 in frame member 123. Toward that end, latch members 210 and 211 are attached to or formed integral with second end 192 of trigger plate 130. Thus, when trigger plate 130 is engaged by a product container 40, 42 as indicated by arrow A in FIGS. 4 and 5, the product container 40, 42 causes trigger plate 130 to pivot about pins 204, 205 as represented by arrow B. Latch members 210 and 211 pivot along with trigger plate 130 as indicated by arrow C such that hook portions 214 are shifted out of openings 220, thereby clearing frame member 128 (see FIG. 5) and allowing gate member 128 to open.

With this overall construction, once a product container 40, 42 is transported onto product delivery system 48, conveyor belt 49 carries product container 40, 42 toward opening 52. As the selected product container 40, 42 reaches opening 52, the selected product container 40, 42 abuts or engages trigger plate 130, causing latch members 210, 211 to deflect or disengage from frame member 123 in order to allow gate member 128 to open. At this point, the selected product container 40, 42 is transported through product opening 144 and guided through chute zone 190 into product dispensing chamber 80 so that a consumer can reach into access opening 82 and withdraw the selected product. After the selected product container 40, 42 passes into chute 190, gate member 128 automatically shifts back to the closed position under the biasing force of torsion spring 185, with latch members 210, 211 projecting into openings 220 and re-engaging with frame member 123. In any event, incorporating gate assembly 120 in opening 52 will prevent unauthorized access to products arranged on shelves 34-38 while, at the same time, enables products to be effectively transported from product storage/display zone 20 into product dispensing chamber 80.

Although described with reference to a preferred embodiment of the present invention, it should be readily apparent to one of ordinary skill in the art that various changes and/or modifications can be made to the invention without departing from the spirit thereof. For instance, the particular location of gate assembly 120 as presented is but one example. Other examples could include other vertical locations on divider wall 18 or in a lower portion of vending machine 2. Also, it should be noted that, while vending machine 2 includes a conveyorized delivery system, other types of product delivery systems could also be employed. In addition, it should be understood that front end 170 of gate member 128 could be hingedly connected directly to divider wall 18. With this modification, divider wall 18 actually defines the discussed frame member and would include the required structure to directly support gate assembly 120. Furthermore, trigger plate 130 may be formed by other structure, such as one or more fingers or rods, rather than by the plate shown. Finally, it should be realized that latch members 210 and 211 could take various forms, while being integrally formed with or separate from trigger plate 130. For instance, latch members 210 and 211 could be spring biased relative to trigger plate 130, while still performing the desired latch and release functions described above. In general, the invention is only intended to be limited to the scope of the following claims.

1. A vending machine comprising:
a cabinet;
a product storage zone arranged within the cabinet;
a product delivery zone arranged within the cabinet;
a dispensing chamber provided in the product delivery zone;
a chute zone interconnecting the product storage zone and the dispensing chamber;
an access opening leading to the dispensing chamber, said access opening enabling removal of a product transferred from the product storage zone to the dispensing chamber through the chute zone;
a door pivotally mounted relative to the cabinet, said door selectively providing access to the product storage zone to enable replenishment of products; and
a gate assembly positioned between the product storage zone and the dispensing chamber, said gate assembly including a gate member and a trigger plate mounted for movement relative to the gate member, said gate member being movable between a closed position, wherein access to the product storage zone from the dispensing chamber is prevented, and an open position, wherein a product can be delivered from the product storage zone to the dispensing chamber, said gate member being shifted from the closed position to the open position upon a product impinging the trigger plate, thereby allowing the product to pass into the dispensing chamber.

2. The vending machine according to claim 1, further comprising: a frame member that defines a product opening, said gate member extending across the product opening in the closed position.

3. The vending machine according to claim 2, wherein the gate member is pivotally mounted relative to the frame member.

4. The vending machine according to claim 3, wherein the gate member is arrange entirely within the frame member when the gate member is in the closed position.

5. The vending machine according to claim 2, further comprising:
a divider wall provided in the cabinet, said divider wall separating the cabinet into the product storage zone and product deliver zone; and
an opening in the divider wall leading from the product storage zone to the product delivery zone, wherein the gate assembly is provided in the opening of the divider wall.

6. The vending machine according to claim 5, wherein the frame member includes a plurality of side walls provided with inner and outer peripheral rim portions, and a plurality of tab elements extending from the inner peripheral rim portion for snap-fittingly mounting the gate assembly in the divider wall.

7. The vending machine according to claim 5, wherein the frame member includes a peripheral flange that extends substantially perpendicularly from the plurality of side walls.

8. The vending machine according to claim 2, wherein the gate assembly includes a latch member pivotally mounted relative to the gate member, said latch member being adapted to engage with the frame member so as to retain the gate assembly in the closed position.

9. The vending machine according to claim 8, wherein the latch member includes a hook portion, said hook portion being adapted to extend into an opening formed in the frame member to retain the gate assembly in the closed position.

10. The vending machine according to claim 9, wherein the trigger plate includes a first end, a second end and a paddle portion, said second end being pivotally mounted relative to the gate member.

11. The vending machine according to claim 10, wherein the latch member is provided on the trigger plate so that deflection of the trigger plate causes the latch member to disengage from the frame member.

12. The vending machine according to claim 11, wherein the gate assembly further includes a spring element interposed between the trigger plate and the gate member, said spring element being adapted to bias the trigger plate away from the gate member.

13. The vending machine according to claim 11, wherein the first end of the trigger plate includes a bifurcated hinge knuckle, said bifurcated hinge knuckle pivotally mounting the trigger plate to the gate member.

14. The vending machine according to claim 13, wherein the latch member is positioned in the bifurcated hinge knuckle.

15. The vending machine according to claim 14, wherein the gate assembly includes first and second latch elements.

16. The vending machine according to claim 10, wherein the trigger plate includes a plurality of raised rib elements extending fore-to-aft between the first end and the second end, said plurality of raised rib elements being formed in the paddle portion.

17. The vending machine according to claim 1, wherein the gate member includes a first end portion, a planar portion, a second end portion and a plurality of raised rib members extending fore-to-aft on the planar portion between the first end portion and the second end portion.

18. The vending machine according to claim 1, wherein the vending machine constitutes a glass front vending machine.

19. The vending machine according to claim 1, further comprising: a product delivery system movable in vertical and horizontal directions for delivering a product container from the product storage zone to the gate assembly.

20. In a vending machine including a product storage zone, a dispensing chamber, a chute zone interconnecting the product storage zone and the dispensing chamber, and a gate assembly including a gate member arranged at the chute zone, said gate member being movable between a closed position and an open position to selectively close a passage between the product storage zone and the dispensing chamber, a method of dispensing a product comprising:
selecting a product arranged in the product storage zone;
moving the selected product within the product storage zone toward the chute zone;
causing the selected product to abut a trigger plate mounted for movement relative to the gate member;
unlatching a latch member upon abutting the trigger plate with the selected product so as to unlock the gate member, thereby allowing the gate assembly to shift from the closed position to the open position;
directing the product through the gate assembly, into the chute zone and toward the dispensing chamber; and
shifting the gate member back to the closed position wherein the latch member locks the gate member in the closed position to prevent access to the product storage zone from the dispensing chamber.

21. The method of claim 20, wherein abutting the trigger plate causes a the trigger plate to pivot relative to the gate member to unlatch the latch member.

22. The method of claim 20, further comprising: biasing the trigger plate away from the gate member through a spring element.
